(19) United States
(12) Patent Application Publication
(10) Pub. No.: US 2017/0090120 A1
(43) Pub. Date: Mar. 30, 2017

(54) WAVEGUIDE FILTER

(71) Applicant: FiberPlex Technologies, LLC, Annapolis Junction, MD (US)

(72) Inventor: Harry S. Oliver, III, Annapolis Junction (US)

(21) Appl. No.: 14/869,964

(22) Filed: Sep. 29, 2015

(51) Int. Cl. G02B 6/26; G02B 6/42

(52) U.S. Cl. CPC G02B 6/264; G02B 6/4248; G02B 6/4277

(57) ABSTRACT

A waveguide filter is provided for functioning as a cable feed-through for previously terminated cables. The waveguide filter includes a housing of pre-determined length having a plurality of bores extending therethrough. One of such of bores is centrally located, with the other bores being located radially about the central bore. The smaller diameter bores form a portion of the waveguide passages. A plug member insertable within the larger diameter bore of the housing forms a closure for the waveguide access openings. The plug member includes at least one longitudinally directed groove extending therethrough. These longitudinally directed grooves in the plug are aligned with the longitudinally directed bores of smaller diameter of the housing to form waveguide passages, thereby allowing a closer tolerance fit with the fiber optic cables for larger diameter cables while maintaining improved performance and alternatively allowing smaller diameter cables while substantially enhancing performance. The plug member is releasably fastened to the housing. Dowel pins extended longitudinally from one end of the plug and the housing and mate with a specially configured flat washer to align the longitudinally directed bores of the housing and the longitudinally directed grooves of the plug.

### FIELD OF THE INVENTION

The present invention relates generally to waveguide filters for providing cable access to a shielded enclosure and waveguide filter feed-throughs for cables previously terminated, and where high frequency attenuation of electromagnetic radiation is required.

### BACKGROUND OF THE INVENTION

Waveguide filters for use as cable feed-throughs are well-known in the art. The recent prior art known to the Applicant includes U.S. Pat. Nos. 4,109,222; 4,267,401; 4,255,616; 4,249,353; 4,693,767 and 4,849,723.

Some prior art systems are directed to waveguides operating below cut-off for providing an optical coupling link through a shielded enclosure. The diameter of the central bore and the length of the waveguide are predetermined to achieve the desired attenuation and cut-off frequency. However, when previously terminated cables are used, the bore diameter is no longer determined by the desired cut-off frequency and attenuation, but is mandated by the size of the terminated connector. To compensate somewhat for the increased bore diameter, the length of the waveguide must be increased, which may not be feasible due to space limitations. Prior art waveguide filters having bore diameters sufficiently large enough to accommodate previously terminated cables exhibit lower performance, with respect to high frequency attenuation, than the smaller bore diameter waveguide filter for use with terminated cables.

Since the diameter of the bore is greatly affects the cut-off frequency, prior art systems attempted to keep the bore diameter as close to the diameter of the previously terminated cable as practical. Duplex fiber optic cables had to be split apart exposing the two individual optical cables and passing each through a waveguide bore or passage.

The invention of U.S. Pat. No. 4,849,723 provided an improved means for inserting the previously terminated duplex fiber optic cable through a single waveguide passage, the waveguide passage having a smaller opening than that required by the other prior art, thus providing improved performance, with respect to cut-off frequency and attenuation.

However, recent demand for bandwidth has substantially increased and has precipitated the need to use higher fiber count cables. The waveguide passages that are created in the prior art do not have fully circular cross-section and do not fit well around the more recent designs of multi-fiber optical cable. What is needed is a further improved waveguide passage design to allow better fit of the waveguide passage to the fiber optic cable thereby allowing larger diameter cables while maintaining improved performance and alternatively allowing smaller diameter cables while substantially enhancing performance.

### SUMMARY OF THE INVENTION

A waveguide filter for functioning as a cable feed-through of previously terminated cables is provided. The waveguide filter has predetermined dimensions for attenuating electromagnetic radiation of predetermined bandwidth, and includes a longitudinally extended housing having at least one longitudinally directed large diameter bore extending therethrough and at one least one longitudinally directed small diameter bore extending therethrough. The smaller diameter bores form a portion of the waveguide passages.

A plug member insertable within the larger diameter bore of the housing forms a closure for the waveguide access openings. The plug member includes at least one longitudinally directed groove extending therethrough. These longitudinally directed grooves in the plug are aligned with the longitudinally directed bores of smaller diameter of the housing to form waveguide passages, thereby achieving a better and closer tolerance fit with the fiber optic cables. The plug member is releasably fastened to the housing.

Dowel pins extended longitudinally from one end of the plug and the housing and mate with a specially configured flat washer to align the longitudinally directed bores of the housing and the longitudinally directed grooves of the plug.

### BRIEF DESCRIPTION OF THE DRAWINGS

The invention may be more fully understood with reference to the accompanying drawing figures and the descriptions thereof. Modifications that would be recognized by those skilled in the art are considered a part of the present invention and within the scope of the appended claims.

FIG. 1 shows an exploded perspective view of the wave guide filter feed-through embodying the inventive concept.

FIG. 2 shows a perspective view of the plug member.

FIG. 3 shows a cut-away exploded plane view of the embodiment of FIG. 1.

FIG. 4 shows a perspective view of the specially designed flat washer.

FIG. 5 shows a fully assembled view of the wave guide filter.

### DETAILED DESCRIPTION OF THE INVENTION

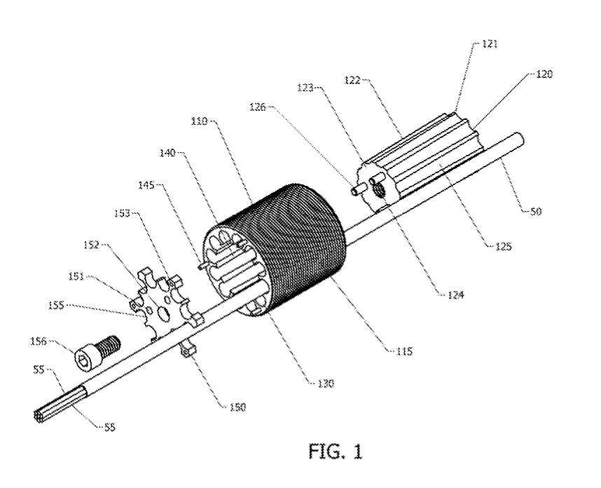

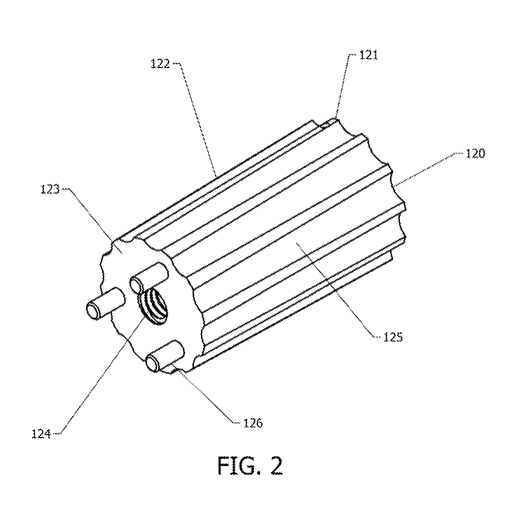

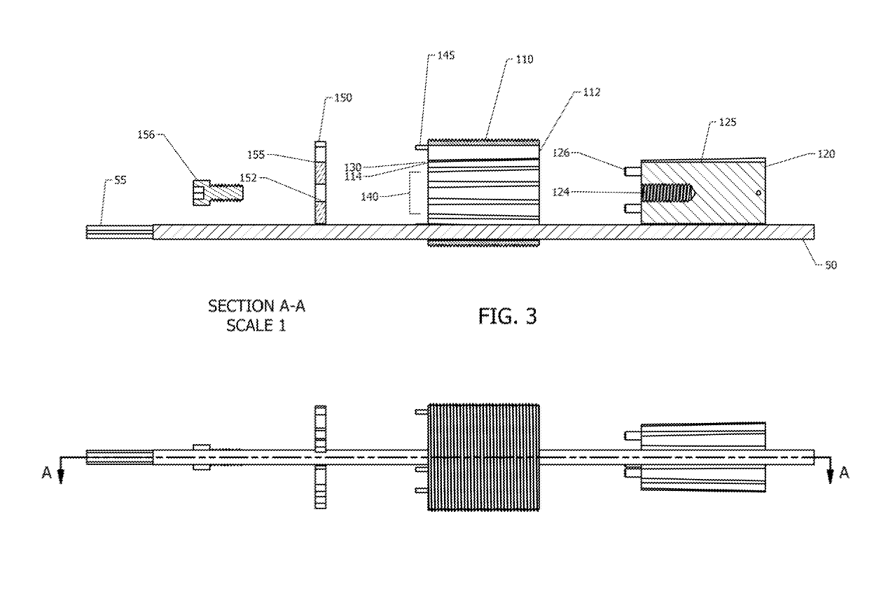

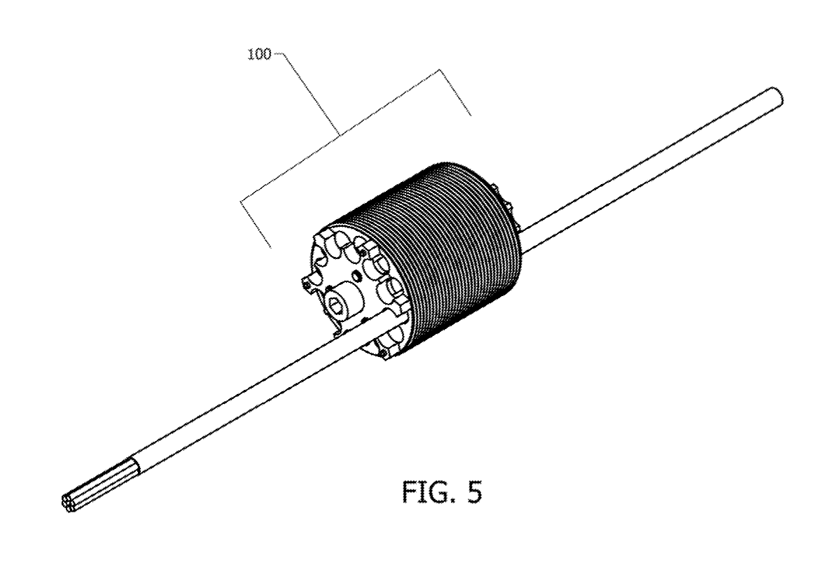

Referring now to FIGS. 1, 2, 3 and 5, there is shown a waveguide filter feed-through 100 for providing a cable access to a shielded enclosure while providing a predetermined frequency vs. attenuation characteristic. As will be seen in following paragraphs, waveguide filter 100 is specifically directed to the concept of providing a cable feed-through for previously terminated cables while maintaining a filter characteristic of high attenuation for high frequency electromagnetic radiation. Waveguide filter feed-through 100 provides the means for inserting the multi-fiber optical cable 50 into the shielded enclosure without significantly separating each of the fiber optic cables 55, which together form the multi-fiber optical cable 50. Simultaneously, waveguide filter feed-through 100 maintains a high frequency attenuation characteristic to substantially prevent radiation of predetermined frequencies of electromagnetic radiation from passing therethrough.

Waveguide filter feed-through 100 is formed by a housing 110 through which a plurality of longitudinally extended bores 130 and 140 are formed therethrough. One of the bores 140 is centrally located within housing 110 and overlaps each of the remaining plurality of bores 130 are located radially around the central passage 140. Each of the longitudinally extended bores 130 and 140 have a common longitudinal access opening extending the length of housing 110. The central bore 140 has a diameter considerably larger than the diameter of longitudinally extended bores 130 to facilitate the unique function of waveguide filter feed-through 100, as will be described in following paragraphs.

A closure for the central bore 140 and each of the longitudinal access openings of the housing 130 is provided by a plug 120 insertable within central bore 140. Plug 120 includes a plurality of longitudinally extended grooves 125 that are located radially around the external diameter of the plug 120 at locations that are radially alignable to those of the longitudinally extended bores 130 of the housing.

Plug 120 is releasably coupled to housing 110, forming a closure for the longitudinal access opening of each longitudinally extended bore 130, and thereby forming the entire circumference of each waveguide passage formed by the longitudinally extended bores 130 of the housing and the longitudinally extended grooves 125 of the plug 120. The diameter formed by these longitudinally extended bores 130 of the housing and the longitudinally extended grooves 125 of the plug 120 can be now made constant around the entire circumference of the waveguide passage, rather than the constrained opening of the prior art, allowing for a better fit around the cable. The invention allows for larger diameter multi-fiber optical cable while maintaining the diameter of the waveguide passage and the attenuation of the filter, and alternatively, allows for a smaller diameter multi-fiber optical cable while decreasing the diameter of the waveguide passage and increasing the attenuation of the filter.

To facilitate precise longitudinal coupling of plug 120 to housing 110, for proper attenuation and operation of the filter, the central bore 140 is tapered to form a conical bore. Thus, the diameter of central bore 140 at the housing first end 112 is larger than the diameter of central bore 140 at the housing second end 114. Plug 120 has a portion 122 similarly tapered to mate with the conical bore 140 of housing 110. Tapered portion 122 of plug 120 has a diameter which decreases linearly from first end 121 to second end 123, permitting plug 120 to be inserted within central bore 140, but preventing it from passing completely through the central bore.

Since the longitudinally extended grooves 125 of the plug 120 form the remaining circumference of each of the waveguide passages, a tight close tolerance fit achieves high frequency attenuation for the waveguide filter feed-through 100.

A means for fastening the plug 120 within the housing 110 is provided to ensure alignment of the longitudinally extended grooves 125 of the plug 120 with the longitudinally extended bores 130 of the housing. A screw type fastening system has been utilized in one working embodiment of waveguide filter feed-through 100, as will be described in following paragraphs. Other methods of fastening plug 120 within the central bore 140 of housing 110 could be utilized without departing from the scope of the inventive concept.

Since the longitudinally extended bores of the plug 120 form the remaining circumference of each of the waveguide passages, tight alignment of the longitudinally extended grooves 125 and the longitudinally extended bores 130 that form the waveguide passage is required. The plug 120 includes at least two dowel pins 126 extending longitudinally outward from the second end 123 of the plug 120. The plug 120 also includes an internally threaded counterbore 124 to accept a threaded screw or other fastener.

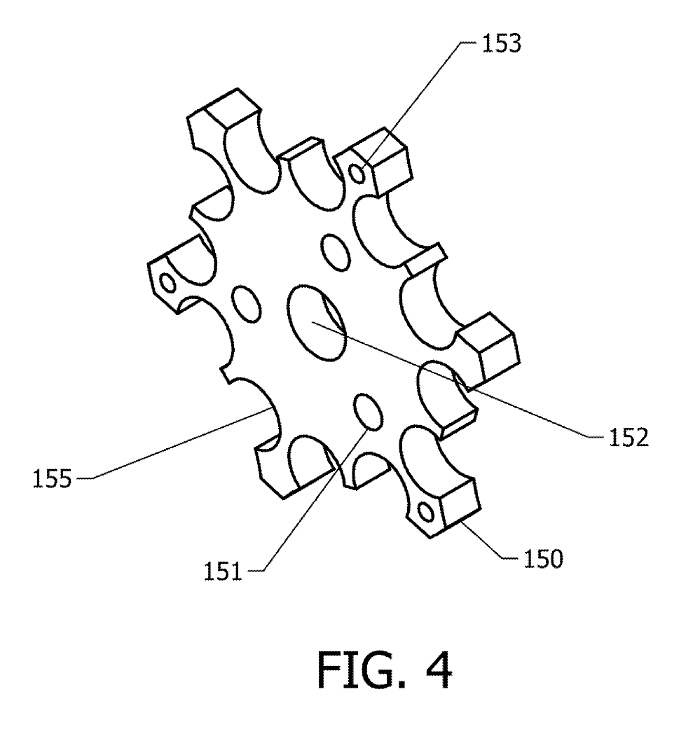

Referring now to FIG. 4, the plug is designed to mate with a flat washer 150. The flat washer includes mating holes 151 to accept the dowel pins 126 of the plug, and mating holes 153 to accept the dowel pins 145 of the housing, thereby aligning the longitudinally extended bores 130 and the longitudinally extended grooves 125. These alignment holes 151 and 153 ensure the precise alignment of the housing 110 and the plug 120 necessary to create the longitudinal bores 125 and 130. The flat washer also includes longitudinally extended grooves 155 that are located radially around the washer. The longitudinally extended grooves are aligned with the longitudinally extended bores of the housing and allow for passage of the fiber optic cables.

With plug 120 inserted within central bore 140, the dowel pins of the plug extend from central bore 140 beyond second housing end 114, and the dowel pins of the housing extend from the end of the housing. Inserting a screw 156 through a center hole 152 in the washer 150, the plug 120 can then be pulled tightly into contiguous contact with central bore 140 by tightening screw 156 into counterbore 124 of plug.

During installation, the plug 120 is removed from central bore 140 in the housing 110, to allow the cables to be inserted therethrough. The diameter of central bore 140 is sufficiently large to allow the optical cable termination connector to easily pass therethrough. Subsequent to passage of each of the pair of termination connectors and their corresponding individual fiber optic cables through central bore 140, the fiber optic cable, comprising the multi-pair of fiber optical cables, may be passed into an unoccupied longitudinally extended bore 130. This procedure may be repeated until all of the longitudinally extended bores 130 contain a cable.

However, it is not necessary to maintain a cable within each of the longitudinally extended bores 130 for proper functioning of the waveguide filter feed-through 100. Each of the individual waveguide filters formed by the longitudinally extended bores 130 and the longitudinally extended grooves 125 maintain the desired filter characteristics regardless of whether, a fiber optic cable 50 is inserted therein.

After the desired number of fiber optic cables has been inserted within respective longitudinally extended bores 130, the plug 120 is inserted into the central bore 140, completing the circumference of each of the waveguide filter openings. The dowel pins extending from the second end 123 of the plug 120 extend through central bore 140 past second end 114 of housing 110, and the dowel pins of the housing extend from the end of the housing, and are mated with the flat washer 150. Using a screw 156, the plug 120 can then be pulled tightly into contiguous contact with central bore 140 by tightening screw 156 into counterbore 124 of plug, providing the high performance waveguide filter feed-through 100 for passage of at least one previously terminated duplex fiber optic cable.

As shown in FIG. 1, housing 110 is a longitudinally extended cylindrically shaped member having threads 115 formed in the outer wall of housing 110. Threads 115 are used to couple waveguide filter feed-through housing 110 to the portion of the shielded enclosure, or bulkhead, through which the cables must pass. The aperture formed in the shielded enclosure, through which waveguide filter feed-through 100 is inserted, may have an internal thread to matingly engage with thread 115. Other methods of securing the waveguide filter feed-through 100 to the wall of a shielded enclosure may also be utilized, such as the addition of attachment flanges, or coupling the housing 110 to the enclosure wall by welding, brazing, soldering, or by electrically conductive adhesive means.

The number of passages formed by the longitudinally extended bores 130 and the longitudinally extended grooves 125, located radially about central bore can vary from one to any number, limited only by their diameter and the diameter of the cylindrical housing 110. In one working embodiment, a housing 110 having an approximating length of 1.687 inches, with six waveguide passages having an approximate diameter of 0.257 inches, surrounding a central bore 140 whose minimum diameter is approximately 0.500 inches has been used successfully.

The smaller diameter of waveguide passages formed when plug 120 is inserted and secured within central bore 140 provides a waveguide filter having a superior high frequency attenuation characteristic, as compared to that of the prior art. In one working embodiment, an attenuation of 100 db is achieved for a frequency of 43.95 GHz, whereas the prior art device achieves only an attenuation of 100 db for a frequency of 22.08 GHz. When the same diameter of waveguide passages is maintained, larger diameter multi-fiber cables can be housed within the waveguide passages formed when plug 120 is inserted and secured within central bore 140 which provides a waveguide filter having a equivalent high frequency attenuation characteristic, as compared to that of the prior art with a higher resulting fiber count per waveguide passage Once the plug 120 is installed within central bore 140, the only openings through which electromagnetic energy radiation may pass are the waveguide passages formed by the longitudinally directed bores 130 and the longitudinally directed grooves 125, whose diameter and length have been predetermined to provide the required attenuation for the intended application.

For passages formed by the longitudinally extended bores 130 and the longitudinally directed grooves 125 to function as a waveguide, the housing 110 and the plug 120 must be formed from an electrically conductive material with the housing 110 being electrically coupled to the ground plane of the shielded enclosure through which it passes. Electrical coupling between housing 110 and plug 120 is provided by the contiguous contact between the tapered portion 122 and the internal surface of the central bore 140, as well as the contact made between the screw 156, and the flat washer 150.

Although this invention has been described in connection with specific forms and embodiments thereof, it will be appreciated that various modifications other than those discussed above may be resorted to without departing from the spirit or scope of the invention. For example, equivalent elements may be substituted for those specifically shown and described, certain features may be used independently of other features, and in certain cases, particular locations of elements may be reversed or interposed, all without departing from the spirit or scope of the invention as defined in the appended claims.

1. A waveguide filter for functioning as a cable feed-through of previously terminated cables, said waveguide filter having predetermined dimensions for attenuating electromagnetic radiation of predetermined bandwidth, comprising:
a longitudinally extended housing having a plurality of longitudinally extended bores therethrough, one of said bores being centrally located with the other said bores being located radially about the first bore; each of said radially located bores forming a first portion of an individual waveguide passage and having a common longitudinal access opening with said centrally located bore for insertion of previously terminated cable, each of said individual waveguides having a diameter less than the diameter of said centrally located bore;
a plug member having a plurality of longitudinally extended grooves being located radially about the circumference of the plug member, said plug member insertable within the centrally located bore of said housing, wherein said longitudinally extended grooves of the plug member form a second portion of an individual waveguide passage and wherein each individual waveguide passage when formed has a circular cross section and a fully enclosed cross-sectional area; and
a fastener for releasably coupling said plug member to said housing.

2. The waveguide filter as recited in claim 1, wherein said centrally located bore of said housing is tapered at a predetermined angle to form a conical bore.

3. The waveguide filter as recited in claim 2, wherein said plug member has a conical contoured portion tapering from a first end to a second end at a predetermined angle to interfitingly mate with said bores of said housing.

4. The waveguide filter as recited in claim 1, wherein said centrally located bore of said housing has a predetermined diameter greater than a diameter of said cable terminations for passage of said terminated cable therethrough.

5. The waveguide filter as recited in claim 3, wherein the outer wall of said housing includes threaded members for threadedly coupling said housing to a bulkhead of a shielded enclosure.

6. The waveguide filter as recited in claim 3, wherein the outer wall of said housing is adapted for coupling said housing to a bulkhead of a shielded enclosure.

7. The waveguide filter as recited in claim 1, wherein the plug member and the housing include at least two dowel pins longitudinally extending away from a first said plug member and said housing for mating with mating holes in a flat washer that is removeably attached to said housing.

8. A cable feed-through system for providing access to a shielded enclosure by previously terminated cables, comprising:
a housing of predetermined length having a plurality of longitudinally extended bores therethrough, a first of said bores being centrally located with the other said bores being located radially about the first bore; each of said radially located bores forming a first portion of an individual waveguide passage and having a common longitudinal access opening with said centrally located bore for insertion of the previously terminated cable, each of said individual waveguides having a diameter less than the diameter of said centrally located bore;
a plug member having a plurality of longitudinally extended grooves being located radially about the circumference of the plug member, said plug member insertable within said centrally located bore of said housing, wherein said longitudinally extended grooves of the plug member form a second portion of said individual wave guides and wherein each individual waveguide passage when formed has a circular cross section and a fully enclosed cross-sectional area;
a fastening means of releasably coupling said plug member to said housing;
a fastening means for coupling said housing to a shield enclosure.

9. The cable feed-through system as recited in claim 8, wherein said centrally located bore of said housing is tapered at a predetermined angle to form a conical bore.

10. The cable feed-through system as recited in claim 9, wherein said plug member has a conical contoured portion tapering from a first end to a second end at a predetermined angle to interfitingly mate with said centrally located bore of said housing.

11. The cable feed-through system as recited in claim 8, wherein said centrally located bore of said housing has a predetermined diameter greater than a diameter of said cable terminations for passage of said terminated cable therethrough.

12. The cable feed-through system as recited in claim 8, wherein the plug member and the housing include at least two dowel pins longitudinally extending for mating with mating holes of a flat washer that is attached removably to said housing.

13. The waveguide filter as recited in claim 7, wherein the flat washer has a plurality of circular shaped cutouts being located radially about the circumference of the flat washer, each such cutout aligning with each waveguide passage to allow the cable to pass through while covering the other areas of the end of the waveguide filter.

14. The cable feed-through system as recited in claim 12, wherein the flat washer has a plurality of circular shaped cutouts being located radially about the circumference of the flat washer, each such cutout aligning with each waveguide passage to allow the cable to pass through while covering the other areas of the end of the waveguide filter.
